(19) United States
(12) Patent Application Publication
(10) Pub. No.: US 2013/0095336 A1
(43) Pub. Date: Apr. 18, 2013

(54) Film Composition for Controlled Peelable Seal Film

(71) Applicant: Becton, Dickinson and Company, Franklin Lakes, NJ (US)

(72) Inventor: Theresa Hermel-Davidock, Newton, NJ (US)

(73) Assignee: Becton, Dickinson and Company, Franklin Lakes, NJ (US)

(21) Appl. No.: 13/650,660

(22) Filed: Oct. 12, 2012

Related U.S. Application Data
(60) Provisional application No. 61/547,820, filed on Oct. 17, 2011.

(51) Int. Cl. B32B 27/08; B32B 27/32

(52) U.S. Cl. 428/516

(57) ABSTRACT

The present invention provides polymeric film and, more particularly, a multi-layer polymeric film including one or more structural layers of homogenous polypropylene; one or more structural layers of random copolymer polypropylene; one or more anhydride modified polyethylene based tie layers; one or more linear low density polyethylene (LLDPE) blend sealant layers having a primary LLDPE component, a secondary LLDPE component, and an optional LDPE additive component.

### TECHNICAL FIELD

Aspects of the present invention relate to polymeric film and, more particularly, relate to a multi-layer polymeric film including one or more structural layers of homogenous polypropylene; one or more structural layers of random copolymer polypropylene; and one or more anhydride modified polyethylene based tie layers and one or more linear low density polyethylene (LLDPE) blend sealant layers having a primary LLDPE component, an optional secondary LLDPE component, and an optional LDPE additive component.

### BACKGROUND

Many of the polymeric films used in industry today still fail to be recyclable. Due to increased environmental awareness and a desire to decrease environmental impact, a need still exist for a recyclable polypropylene/polyethylene film having tailor-able physical and sealant properties, for example, good formability, toughness and impact strength at thin gauges. Moreover, despite advances in polyethylene peelable sealant technology, poor seal performance and a narrow seal processing window to direct seal paper can occur as a result of a failure to optimize sealant performance. For example, too strong of a peel strength results in fiber tear and too weak of peel strength may compromise a sterile product.

European Patent EP 1 736 309 A1 entitled “Packaging Obtained by Direct Contact Seal” discloses a direct contact seal comprising a coextruded multilayer film composed of a polyolefin based seal layer with a Tm<135° C., comprised up to 30% polybutene-1 for peel-seal applications and a second polypropylene based support layer with a Tm>135° C. However, the film of EP 1 736 309 requires the addition of polybutene-1 and/or a specific Tm and modulus difference between the seal layer and support layer.

European Patent EP 1 453 671 B1 entitled “Peelable Seal Film” discloses a heat sealable coextruded multilayer film peelable to a variety of substrates. The seal layer is comprised of 50-80 wt % ethylene homo &/or copolymer, 15-25 wt % styrene homo &/or copolymer, and 5-20 wt % thermoplastic elastomer SBS copolymer, with preference for the addition of 10-20 wt % homogeneously branched LLDPE to control peel-seal. However, European Patent EP 1 453 671 B requires the addition of SBS or styrene homo &/or copolymer.

International Patent Publication WO 03/04343816 A1 entitled “Peelable Seal Film” discloses a heat sealable coextruded multilayer film peelable to a variety of substrates. The seal layer is comprised of 50-80 wt % ethylene homo &/or copolymer, 15-25 wt % styrene homo &/or copolymer, and 5-20 wt % thermoplastic elastomer SBS copolymer, with preference for the addition of LLDPE and/or polybutylene-1 to control peel-seal. Similar to European Patent EP 1 453 671 B1, International Patent Publication WO 03/04343816 requires the addition of SBS or styrene homo &/or copolymer.

U.S. Pat. No. 5,681,523A entitled “Medium Modulus Polyethylene Film and Fabrication Method” discloses a film comprised of a high molecular weight linear PE (0.92-0.96 g/cc & 0.1 to 3 MI) and linear ethylene/alpha-olefin interpolymer (0.85 to 0.92 g/cc & 0.3 to 3 MI), with an overall density between 0.923 to 0.95 g/cc. Additional background examples given included: a) LLDPE w/LDPE, b) HDPE w/rubber or other elastomer, c) LLDPE w/low MW HDPE, d) LLDPE w/high MFR HDPE, and LLDPE w/an isotactic polymer. It was noted in the body of the patent that increasing the gauge does not proportionately enhance the physical properties of the film. The overall density range of the films disclosed in US 005681523A prevent an effective low temperature heat seal and hot tack performance. US 005681523A fails to address seal performance of the film disclosed therein.

U.S. Patent Publication No. 2003/0143416A1 entitled “Layered Film and Packaging Product Thereof” and U.S. Pat. No. 6,794,029B2 entitled “Layered Film and Packaging Product Thereof” disclose layered film comprised of at least two layers of a resin: composition layer A) 60-90 mass % LLDPE produced using a single-site catalyst and 40-10% mass % of polybutene-1 and layer B) HDPE (0.950-0.970). U.S. Patent Publication No. 2003/0143416A1 and U.S. Pat. No. 6,794,029B2 require the addition of polybutene-1 to the seal layer.

International Patent Publication WO 2006/108266A1 entitled “Dual Reactor Polyethylene Resins for Medical Packaging—Films, Bags and Pouches” and U.S. Patent Publication No. 2006/0235146A1 entitled “Dual Reactor Polyethylene Resins for Medical Packaging—Films, Bags and Pouches” disclose tandem dual reactor solution phase polymerization in the presence of a phosphinimine catalyst and a co-catalyst system which comprises an aluminum based co-catalysts.

U.S. Pat. No. 6,632,521B2 entitled “Polymeric Films and Packages Produced Therefrom” and EP 1167437A1 entitled “Polymeric Films and Packages Produced Therefrom” disclose polymeric films having a least one outer layer consisting of a blend of LDPE (0.915-0.930 g/cc and MFI 2.0-40.0 g/10 min) and a poly(alkylstyrene).

U.S. Patent Publication No. 2002/0160135A1 entitled “Polymeric Films and Packages Produced Therefrom” and International Patent Publication WO 01/66639A1 entitled “Polymeric Films and Packages Produced Therefrom” disclose heat sealable films comprised of a seal layer blended of at least one polyethylene and a cyclic olefin/ethylene copolymer having a Tg>30° C.

Therefore, due to increased environmental awareness and a desire to decrease environmental impact, a need exists in the industry to create a recyclable universal polypropylene/polyethylene film with tailor-able physical and sealant properties. It is desirable to produce polypropylene films having the comparable sealing performance to that of traditional polyethylene based sealant structures; with improved properties, such as enhanced optical properties(high clarity/low haze), improved formability, and improved mechanical properties, including high toughness and impact strength.

### SUMMARY OF THE INVENTION

One or more embodiments of the present invention create a recyclable universal flexible, thermoformable film comprised of polypropylene/polyethylene with tailor-able physical and sealant properties.

In one aspect of the present invention, a multi-layer polymeric film is provided that comprises one or more structural layers of homogenous polypropylene having a melt flow rate from 0.5 to 10 MFR; one or more structural layers of random copolymer polypropylene having a melt flow rate from 0.5 to 10 MFR; one or more anhydride modified polyethylene based tie layers having a melt index from 0.7 to 3.5, one or more linear low density polyethylene (LLDPE) blend sealant layer having a primary LLDPE component,; wherein the multi-layer polymeric film has an elongation at break measured in accordance with ASTM D 882 of greater than 400%; Spencer impact strength measured in accordance with ASTM D 3420 of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C. The one or more LLDPE blend sealant layer may also comprise a secondary LLDPE component and/or a LDPE additive component.

The primary LLDPE component may comprises a low long chain branching and heterogeneous molecular weight and short chain branching (comonomer) distribution. The secondary LLDPE component may comprise a low long chain branching and a homogeneous molecular weight and short chain branching comonomer distribution. The one or more structural layers of homogenous polypropylene may contain up to 50% random copolymer or a polypropylene or polyethylene based plastomer/elastomer.

In another aspect of the present invention, a multi-layer polymeric film is provided that comprises one or more layer of high density polyethylene (HDPE) having a melt index from 0.7 to 3.5, one or more anhydride modified polyethylene based tie layers having a melt index from 0.7 to 3.5; one or more structural layers of homogenous polypropylene having a melt flow rate from 0.5 to 10 MFR; one or more structural layers of random copolymer polypropylene having a melt flow rate from 0.5 to 10 MFR; a linear low density polyethylene (LLDPE) blend sealant layer having a primary LLDPE component; wherein the multi-layer polymeric film has an elongation at break of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C. wherein the elongation at break is measured in accordance with ASTM D 882; Puncture is measured in accordance with ASTM D7192; Spencer impact is measured in accordance with ASTM D 3420; and ultimate seal strength is measured in accordance with ASTM F88-07a. The one or more LLDPE blend sealant layer may also comprise a secondary LLDPE component and/or a LDPE additive component.

In one or more embodiments, the one or more layer of HDPE may be from 0 to 30 weight percent and the structural layer of homogenous polypropylene may be from 10 to 60 weight percent of the film based on the total weight of the film and optionally being not directly exposed to the external environment.

In one or more embodiments, the one or more structural layer of homogenous polypropylene may be a Metallocene catalysized based isotactic homoPP resin.

In one or more embodiments, the one or more structural layer of random copolymer polypropylene may be from 20 to 70 weight percent of the film and the one or more sealant layer may be from 10 to 35 weight percent of the film based on the total weight of the film. The one or more structural layers of random copolymer polypropylene may have an alpha olefin comonomer of 1-5%, with a comonomer of ethylene.

In one or more embodiments, the secondary LLDPE component of the blend sealant layer may be a Metallocene or post-Metallocene catalysized resin in an amount from 0 to 40 weight percent of the sealant layer blend, based on the total weight of the sealant layer blend. In another embodiment, the secondary LLDPE component of the blend sealant layer may be a second heterogeneous catalysized LLDPE. The secondary LLDPE component of the blend sealant layer may have a density in the range from 0.850 to 0.930 g/cm3 and a melt index from 0.7 to 3.5 MI.

The primary LLDPE component of the blend sealant layer is a Ziegler-Natta catalysized resin in an amount from 60 to 100 weight percent of the sealant layer blend, based on the total weight of the sealant layer blend. The primary LLDPE component of the blend layer may have a density in the range from 0.850 to 0.930 g/cm3 and a melt index from 0.7 to 3.5 MI.

In one or more embodiments, the additive of the blend sealant layer may be a low density polyethylene (LDPE) in an amount from 0 to 40 weight percent of the sealant layer blend, based on the total weight of the sealant layer blend. The additive LDPE component of the blend sealant layer may have a density in the range from 0.910 to 0.935 g/cm3.

In one or more embodiments, one or more layers of HDPE may have a density in the range from 0.94 to 0.97 g/cm3.

The peel strength of the films may be in the range of 100 gf/in to 2000 gf/in. The multi-layer polymeric film is thermoformable and recyclable.

Yet another aspect of the present invention pertains to various applications of the polymeric film described herein including but not limited to, use in blister packaging, vertical or horizontal form fill seal packaging and flow wrap.

### BRIEF DESCRIPTION OF THE DRAWINGS

FIG. 1 shows an embodiment of the multi-layer polymeric film of the present invention having a layer of high density polyethylene (HDPE); an anhydride modified polyethylene based tie layer; a first structural layer of homogenous polypropylene; a second structural layer of random copolymer polypropylene; a second anhydride modified polyethylene based tie layer; and a linear low density polyethylene (LLDPE) sealant layer; and

FIG. 2 shows an embodiment of the multi-layer polymeric film of the present invention having a first structural layer of homogenous polypropylene; a second structural layer of random copolymer polypropylene; an anhydride modified polyethylene based tie layer; and a linear low density polyethylene (LLDPE) sealant layer.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

The present invention relates to a multi-layer polymeric film comprised of only olefin based polymers offering performance and low cost. With the use of one or more polypropylene layers, anhydride modified polyethylene based tie layers, and polyethylene (PE) sealant layers, the multi-layer polymeric film of the present invention provides for a recyclable and sustainable film. One or more embodiments of the present invention relates to various applications for the polymeric film described herein including, but not limited to, vertical or horizontal form fill seal packaging, pouch film, flow wrap; and top and bottom web polymeric film for flexible blister packaging, such as in primary packaging for medical devices. One or more embodiments of the present invention provide a universal polymer film with tailor-able physical and sealant properties through modification of the gauge, % support layer, and sealant layer composition, including resin selection and blend ratio. The PE based sealant layer composition can be comprised of a blend of linear low density polyethylene (LLDPE) resins, including ethylene based elasotomers or plastomers. The sealant performance of the film can be tailored by adjusting the ratio of the two LLDPE components, and based on the PE resin selections, including molecular weight (MW), MW distribution, comonomer (or short chain branching) type, comonomer content, comonomer distribution, and long chain branching content. The sealant performance of the film can be further tailored by blending with a high density polyethylene (HDPE), medium density polyethylene (MDPE), low density polyethylene (LDPE), or other alpha olefin copoylmers.

Embodiments of the present invention provide seal performance to sealant coated paper, polymeric nonwovens such as Tyvek and those coated with a sealant layer, top web polymer based films and uncoated, or direct seal, paper comparable to packaging resins such as ionomers (Surlyn) and copolymers like ethylene vinyl acetate (EVA), while allowing for a broad processing window, optimization of peel strength, cost-savings and recyclability.

The components of the polymeric film of the present invention are discussed in more detail below.

### Layer of High Density Polyethylene (HDPE)

One or more layers of the multi-layer polymeric film 10 may be comprised of a layer of high density polyethylene (HDPE) 20 wherein each layer of high density polyethylene (HDPE) may be from 0 to 30 weight percent, based on the total weight of the film. The layer of HDPE is characterized by having a density in the range from 0.94 to 0.97 g/cm3. The layer could optionally be comprised of a LLDPE, preferably a metallocene or post-metallocene catalyzed resin with a melt index from 0.7 to 3.5 MI, most preferably 1 to 2 MI, with a density range from 0.850 to 0.930 g/cm3. A Z.N. catalyzed LLDPE at the same MI and density ranges could also be used. A 0-40% blending of LDPE, preferably 0-20%, could optionally be added. With the LDPE having a melt index of 0.7-3.5 MI, most preferably 1-2 MI, and a density range from 0.910 to 0.93 g/cm3.

### Tie Layer

One or more tie layers 30 comprised of a anhydride modified LLDPE may be present in the multi-layer polymeric film, wherein each tie layer may be in the range from 0 to 15 weight percent of the film, based on the total weight of the film. The tie layer 30 is characterized by having a density in the range from 0.908 to 0.935 g/cm3. In a specific embodiment of the present invention, the tie layer 30 is characterized by having a melt index from 1 to 2 MI. Additionally, additional LLDPE and/or a low density PE (LDPE) could be blended into the tie layer or sealant layer structure as a cost reduction.

### Structural Layer of Homopolypropylene

One or more structural layer of the multi-layer polymeric film 10 may be comprised of homopolypropylene resin 40 wherein each layer of homopolypropylene resin may be may be from 10 to 60 weight percent of the film, based on the total weight of the film. A melt flow rate from 0.5 to 10 MFR can be utilized, targeted to the physical properties desired. Metallocene-based isotactic PP could be utilized for enhanced optical and mechanical properties and lower coefficient of friction (CoF) if a surface layer.

### Structural Layer of Random Ethylene Copolymer PP

One or more structural layer of the multi-layer polymeric film 10 may be comprised of random ethylene copolymer polypropylene (PP) 50 wherein each layer of random ethylene copolymer PP may be from 20 to 70 weight percent of the film, based on the total weight of the film comprised of a random ethylene copolymer PP. The structural layer of random ethylene copolymer PP 50 is characterized by having an alpha olefin comonomer of 1-5%, with a comonomer of ethylene. A melt flow rate from 0.5 to 10 MFR can be utilized, targeted to the physical properties desired.

### Linear Low Density Polyethylene (LLDPE) Sealant Layer

The multi-layer polymeric film 10 may be comprised of one or more linear low density polyethylene (LLDPE) sealant layers 60 wherein each LLDPE sealant layers is from 10 to 35 weight percent of the film, based on the total weight of the film. The one or more sealant layer 60 is characterized by having an overall density in the range from 0.880 to 0.930 g/cm3. The one or more sealant layer 60 is further characterized by having a melt index from 0.7 to 3.5 MI. In a specific embodiment of the present invention, the one or more sealant layers have a melt index from 1 to 2 MI.

The primary LLDPE component of the one or more sealant layers comprises a low long chain branching and heterogeneous molecular weight and short chain branching (comonomer) distribution. The primary LLDPE component of the blend sealant layer is a Ziegler-Natta catalysized resin in an amount from 60 to 100 weight percent of the sealant layer blend, based on the total weight of the sealant layer blend. In one or more embodiments of the present invention, the Ziegler-Natta catalysized resin is in an amount from 70 to 80 weight percent of the sealant layer blend, based on the total weight of the sealant layer blend. The primary LLDPE component of the blend sealant layer is characterized by having a density in the range from 0.850 to 0.930 g/cm3. In one or more embodiments, the primary LLDPE component of the blend sealant layer has a melt index from 0.7 to 3.5 MI. In one or more embodiments, the primary LLDPE component of the blend sealant layer is further characterized by having a melt index from 1 to 2 MI. The primary LLDPE component of the sealant layer can also include a heterogeneous branched, linear ethylene interpolymer, elastomer or plastomer.

The optional secondary LLDPE component comprises a low long chain branching and a homogeneous molecular weight and short chain branching comonomer distribution. The secondary LLDPE component of the blend sealant layer is a Metallocene or post-Metallocene catalysized resin in an amount from 0 to 40 weight percent of the sealant layer blend, based on the total weight of the sealant layer blend. In one or more embodiments of the present invention, the secondary LLDPE component of the blend sealant layer has a melt index from 0.7 to 3.5 MI. In a specific embodiment of the present invention, the secondary LLDPE component of the blend sealant layer has a melt index from 1 to 2 MI.

The optional secondary LLDPE component of the blend sealant layer is characterized by having a density in the range from 0.850 to 0.930 g/cm3. The secondary LLDPE component of the sealant layer can also include a homogeneous branched, linear ethylene interpolymer, elastomer or plastomer.

### Additive of the Blend Sealant Layer

The additive of the blend sealant layer is a low density polyethylene (LDPE) in an amount from 0 to 40 weight percent of the sealant layer blend, based on the total weight of the sealant layer blend. In a specific embodiment of the present invention, the additive is in an amount from 20 to 30 weight percent of the sealant layer blend, based on the total weight of the sealant layer blend. The additive component of the blend sealant layer is characterized by having a density in the range from 0.910 to 0.935 g/cm3. The additive component of the blend sealant layer is characterized by having a melt index in the range from 0.7 to 3.5 MI. In a specific embodiment of the present invention, the additive component of the blend sealant layer has a melt index from 1 to 2 MI. The peel strength is in the range of 100 gf/in to 2000 gf/in. A medium density PE (MDPE) or high density PE (HDPE) could so be used. A second Z.N. catalyzed LLDPE with a MI and density lower than the primary sealant resin could also be used.

Additives include, but are not limited, anti-static agents, anti-oxidant agents (such as hindered phenolic s (e.g. Tetrakis(methylene-3-(3,5-di-tert-butyl-4-hydroxyphenyl)propionate)methane) like Irganox™ 1010 from BASF or Songnox 1010™ from Songwon) or (e.g. octadecyl-3-(3,5-di-tert-butyl-4-hydroxyphenyl)propionate like Irganox™ 1076 from BASF), UV stabilizers (e.g. N,N-distearylhydroxylamine like Irgastab FS 042 from BASF or Hindered Amine Light Stabilizer (HALS) such as Bis(1,2,2,6,6-pentamethyl-4-piperidinyl)sebacate like BLS 929 from Mayzo, Inc. and triphenylphospate from Bayer), radiation stabilizers, slip agents, anti-block agents, clarifying agents, nucleating agents, anti-yellowing agents, processing aids, colorants, fillers, stiffening or toughening agents, pigments, blowing agents, plasticizers such as di-isononyl phthalate (DINP), crosslinking agents, and cling additives.

Additional examples of additives that could be utilized in any, or all, layer of the film structure include, but are not limited to, Tris(3,5-di-tert-butyl-4-hydroxybenzl)iso-cyanurate; 1,3,5-Trimethyl-2,4,6-tris(3,5-di-tert-butyl-4-hydroxybenzyl)benzene; Tri(butylcresyl)butane; N,N′-Hexamethylenebis(3,5-di-tert-butyl-4-hydroxyhydrocinnamamide); 4-ethyl-2,6-di-tert-butylphenol; N,N-distearylhydroxylamine; Tris(2,4-di-tert-butylphenyl)phosphite; Bis(2,4-di-tert-butylphenyl)pentaerythritol diphosphite; Distearyl pentaerythritol diphosphite; triphenylphosphate; Poy[6-[1,1,3,3-tetramethyl butyl)amino]-s-triazine-2,4-dinyl][2,2,6,6-tetramethyl-4-piperidyl)iminolhexamethylene[2,2,6,6-tetramethyl-4-piperidyl]iminol]; polymer of dimethyl succinate and 4-hydroxy-2,2,6,6-tetramethyl-1-piperidine ethanol; Bis(2,2,6,6-tetramethyl-4-piperidinyl)sebacate; hexadecyl-3,5-di-tert-butyl-4-hydroxybenzoate; 2-hydroxy-4-n-octoxybenzophenone; 2-(2′-hydrox-5′-methylphenyl)benzotriazole; and 2-[2′-hydroxy-3′,5′-di(1,1-dimethylbenzyl)phenyl]-2H-benzotriazole.

The physical and processing properties of the film of the present invention can be tailored by changing the fraction of the structural layer(s) in the overall composition or by altering the ratio of the homo and random polypropylene layers, PP resin selection including the reactor, catalyst and visbreaking technology, melt flow rate (MFR) and/or ethylene comonomer content, and use of additives such as nucleating agents or by changing the overall gauge of the film. The sealant performance of the film can be tailored by the blending of additional LLDPE components, and PE resin selections, including MW, MW distribution, comonomer type, comonomer (or short chain branching) content, comonomer distribution, and long chain branching content. The sealant performance of the film can be further tailored by blending with an HDPE, LDPE, or other alpha olefin copoylmers such as plastomers or elastomers. The LLDPE has a low long chain branching and heterogeneous molecular weight distribution (MWD) & short chain branching (comonomer) distribution (SCBD), which can be achieved by a Ziegler-Natta catalyst. The amount of the heterogeneous LLDPE, and molecular properties of the resin selects, in the sealant layer will govern the seal performance, including: heat seal & hot tack initiation temperature, breadth of hot tack & heat seal window, and ultimate hot tack & heat seal strength. The optional secondary LLDPE component has a low long chain branching and a homogeneous molecular weight and short chain branching (comonomer) distribution, MWD & SCBD, respectively. This can be achieved by a Metallocene catalyst, preferably a post-Metallocene catalyst. The sealant performance of the film can be tailored by blending of additional LLDPE components. The sealant performance of the film can be further tailored by blending with an HDPE, LDPE, or other alpha olefin copoylmers such as plastomers or elastomers. In a specific embodiment, the preferred overall melt index (MI) is 1-3 MI and overall density 0.910 to 0.918 g/cc.

The optional homogenous LLDPE component provides higher ultimate hot tack and seal strength due to its low level of long chain branching and narrow MW and short chain branching (SCB) distributions. The broad MW and SCB distribution of the heterogeneous LLDPE component provides a measurable heat seal and hot tack strength at lower temperatures and broadens out the hot tack and heat seal window.

The optional second heterogeneous LLDPE component, having a low MI and MW than the base Z.N. catalyzed LLDPE would provide a measurable heat seal and hot tack strength at further lower temperatures and broadens out the hot tack and heat seal window further. This could also be achieved through the addition of LDPE. The LDPE would serve as a low cost additive and offer increased bubble stability during the blown film fabrication process.

Therefore by adjusting the wt % of the LLDPE or LDPE components one can tailor the seal strength of the film to ensure a proper peelable seal without fiber tear or other undesirable packaging failure modes. Higher levels of the homogenous LLDPE component could be utilized to create a welded seal, if desired.

HDPE may be used as a surface layer to ensure that the film does not stick during the packaging forming process due to its higher melting point compared to LLDPEs. Buried PP will offer increased stability to environmental exposure of the film over the lifetime of the packaged product. For additional enhanced performance, including decreased haze and physical toughness, a Metallocene or post-Metallocene catalysized LLDPE could be used in place of the HDPE. A Z.N. LLDPE could also be used in place of the HDPE with the potential for additional LDPE from 0-40% for lower cost and bubble stability.

Subsequently, the physical and formability properties of the film could be tailored by the selection of the polypropylene, or blends thereof. The homo-polypropylene would offer high barrier properties, while offering high stiffness and toughness, as well as high clarity if a nucleating agent or clarifying agent is utilized, and chemical and temperature resistance. Polypropylene is inexpensive, easy to process and recyclable. The addition of a random copolymer polypropylene provides enhanced toughness, impact resistance, flexibility and improved optics. The addition of an impact copolymer polypropylene provides optimal impact/stiffness balance. To preserve recyclability, the films of the present invention do not contain any siloxane, vinyl acetate, styrene, alkylstyrene, vinyl alcohol, chlorides, phthalates, acrylates, acrylic acids, glycolic acids, methacrylic acids, vinyl acetates, urethanes, acrylics, or anhydrides.

The homo-polypropylene, random-PP, anhydride modified LLDPE and Z.N and m-LLDPE resins for use in the polymeric film structure of the present invention are all commodity grade olefinic resins, offering a cost advantage over higher performance packaging resins such as ionomers (Surlyn) and copolymers like ethyl vinyl acetate (EVA). Down gauging and using commodity resins offers a further green advantage and would be a lower cost.

The LLDPE resin proposed for the sealant layer a commodity grade PE resins, offering a cost advantage over the current best-in-class EVA or ionomer resins while providing comparable sealant performance. The broad hot tack and heat seal window offered by the LLDPE sealant layer of the present invention results in a more robust production window. Additionally, a film comprising a polypropylene structural layer, anhydride modified polyethylene based tie layer, and polyethylene sealant layer provides for recyclability.

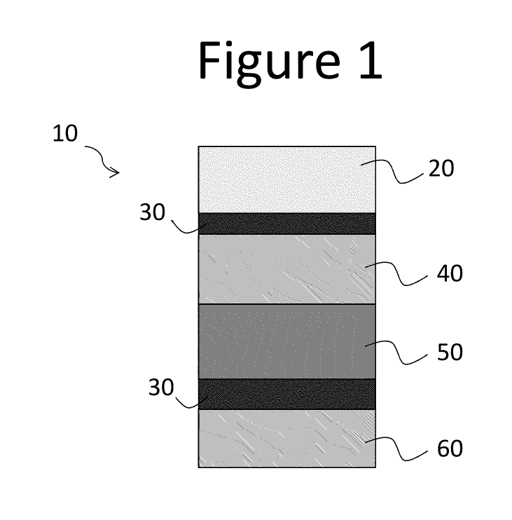

FIG. 1 shows an embodiment of a multi-layer polymeric film 10 the present invention comprising an optional layer 20 of high density polyethylene (HDPE); an anhydride modified polyethylene based tie layer 30; a first structural layer 40 of homogenous polypropylene being not directly exposed to the external environment; a second structural layer 50 of random copolymer polypropylene; a second anhydride modified polyethylene based tie layer 30; and a linear low density polyethylene (LLDPE) blend sealant layer 60 having a primary LLDPE component, an optional secondary LLDPE component, and an optional low density polyethylene (LDPE) additive component. With respect to FIG. 1, the layer of high density polyethylene (HDPE) comprises from 0 to 30 weight percent of the film, preferably 10 to 20% weight percent of the film, based on the total weight of the film and has a melt index from 0.7 to 3.5. The first and second tie layers of anhydride modified polyethylene each comprise from 0 to 15 weight percent of the film, preferably 10% weight percent of the film, based on the total weight of the film and may have a carrier resin having a melt index from 0.7 to 3.5. The first structural layer of homopolypropylene comprises from 10 to 50 weight percent of the film, preferably 10 to 30% weight percent of the film, based on the total weight of the film and has a melt flow rate from 0.5 to 10 MFR. The second structural layer of random copolymer polypropylene comprises from 20 to 70 weight percent of the film, preferably 30 to 40% weight percent of the film, based on the total weight of the film and has a melt flow rate from 0.5 to 10 MFR. The linear low density polyethylene (LLDPE) blend sealant layer 60 comprises from 10 to 35 weight percent of the film, preferably 10 to 20% weight percent of the film, based on the total weight of the film and has a primary LLDPE component, an optional secondary LLDPE component, and an optional LDPE component. A multi-layer polymeric film, as shown in FIG. 1, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C. wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a. The film is recyclable and has a gauge in the range from 1 mil to 80 mil.

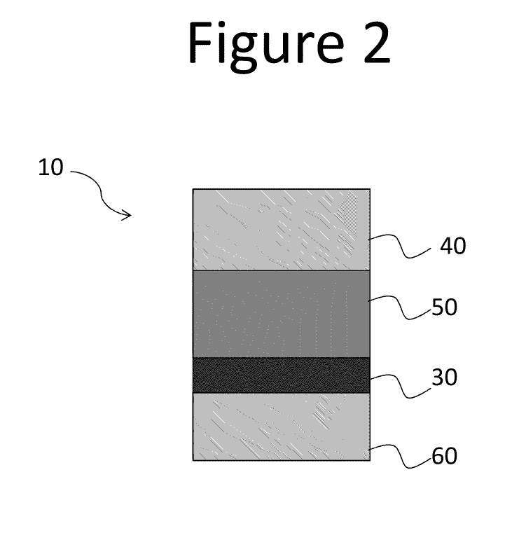

FIG. 2 shows another embodiment of a multi-layer polymeric film 10 of the present invention comprising a first structural layer 40 of homogenous polypropylene; a second structural layer 50 of random copolymer polypropylene; a anhydride modified polyethylene based tie layer 30 (or layers); and a linear low density polyethylene (LLDPE) sealant layer 60 having a primary LLDPE component, an optional secondary LLDPE component, and an optional LDPE additive component. With respect to FIG. 2, the first structural layer of homogenous polypropylene 40 comprises from 20 to 60 weight percent of the film, preferably 20 to 40% weight percent of the film, based on the total weight of the film and has a melt flow rate from 0.5 to 10 MFR. The second structural layer of random copolymer polypropylene 50 comprises from 30 to 70 weight percent of the film, preferably 30 to 50% weight percent of the film, based on the total weight of the film and has a melt flow rate from 0.5 to 10 MFR. The anhydride modified polyethylene based tie layer (or layers) 30 comprises from 5 to 15 weight percent of the film, preferably 10% weight percent of the film, based on the total weight of the film and has a melt index from 0.7 to 3.5. The linear low density polyethylene (LLDPE) blend sealant layer 60 comprises from 10 to 35 weight percent of the film, preferably 15 to 20% weight percent of the film, based on the total weight of the film and has a primary LLDPE component, an optional secondary LLDPE component, and an optional LDPE component. A multi-layer polymeric film, as shown in FIG. 2, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C. wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a.

In one or more embodiments, the hot tack window is greater than 20° C. In one or more embodiments, the ultimate hot tack strength of the polymeric film is more than 50 gf/in.

In one or more embodiments of the present invention, applications of the polymeric film described herein include, but not limited to, use in blister packaging; vertical or horizontal form fill seal packaging; pouch film, and flow wrap packaging.

In one or more embodiments of the present invention, the multi-layer polymeric film has an elongation at break measured in accordance with ASTM D 882 of more than 400%.

In one or more embodiments of the present invention, the multi-layer polymeric film has a Spencer impact measured in accordance with ASTM D 3420 of more than 800 mJ.

In one or more embodiments of the present invention, the multi-layer polymeric film has a Puncture measured in accordance with ASTM D 7192 of more than 7 lbs.

In one or more embodiments of the present invention, the multi-layer polymeric film has a seal initiation temperature less than or equal to 120° C.

In one or more embodiments of the present invention, the multi-layer polymeric film has a seal strength measured in accordance with ASTM F88-07a in the range of 100-2000 gf/in.

In one or more embodiments of the present invention, the multi-layer polymeric film has a seal window greater than 30° C.

The film is thermoformable and entirely recyclable.

### Manufacturing

The multi-layer film structure of the present invention may be fabricated using known conventional blown, cast, extruded or laminate film techniques. The LLDPE sealant blends, and all other blends and potentially all other additives described previously, could be melt blended, compounded in or dry blended, relying on the extruder of the film fabrication line extruded to blend the two components, eliminating the additional cost of a secondary compounding step.

Film properties given in claims are based on blown films with a 5 mil gauge with a blow-up ration of 1.5:1.

### Description of Test Methods

Haze and Luminous transmittance of transparent plastics is measured in accordance with ASTM D-1003-07 and is reported as percent haze, to the nearest 0.1%. As defined in ASTM D-1003-07, haze is the scattering of light by a specimen responsible for the reduction in contrast of objects viewed through it.

Impact resistance is defined as the determination of the energy that causes plastic film to fail under specified conditions of impact of a free-falling dart and is measured in accordance with ASTM D1709-08. Impact resistance is reported as impact failure weight, to the nearest 1 g.

Hot seal strength (hot tack) is defined as measurement of the strength of heat seals formed between thermoplastic surfaces of flexible webs, immediately after a seal has been made and before it cools to ambient temperature. Hot seal strength (hot tack) is measured in accordance with ASTM F-1921 and is reported as units of gf/in.

Seal strength, also referred to as peel strength, is defined as force per unit width of seal required to separate progressively a flexible material from a rigid material or another flexible material and is measured in accordance with ASTM F88-07a and is reported as units of gf/in. Seal strength for the film of the present invention is in the range from 100 gf/in min to 2000 gf/in max. Seal Strength measurements are conducted using a standard bar sealer when heat sealed to self, top seal bar at 280 F, 1.0 s Dwell, 50 psi. Heated bottom bar @100 F, Gasket type (Silicone Rubber, 60 Shore A, ⅛″ thick, Medium (Diamond, 0.012″ resolution)), sealing sample prepared 24 hrs prior to peeling test.

Densities are measured in accordance with ASTM D-792 and are reported as grams/cubic centimeter (g/cc).

Melt index measurements are performed according to ASTM D-1238. Melt index is inversely proportional to the molecular weight of the polymer. Thus, the higher the molecular weight, the lower the melt index, although the relationship is not linear. Melt index is reported as g/10 minutes. Melt index determinations can also be performed with even higher weights, such as in accordance with ASTM D-1238. ASTM D-1238 is also used to determine the melt flow rate (MFR) of a thermoplastic material. The units of measure are grams of material/10 minutes (g/10 min). It is based on the measurement of the mass of material that extrudes from the die over a given period of time.

Spencer impact strength measured in accordance with ASTM D 3420 for the determination of resistance of film to impact-puncture penetration. The average impact strength is measured in joules or centimeters kilograms-force.

Slow rate puncture measured in accordance with ASTM D7192 for the determination of the resistance of the film to puncture. The average puncture strength is measured in pounds-force.

Tensile properties for the film are measured in accordance with ASTM D882. The elongation at break is a measure of the amount of deformation the film is capable of prior to break. Elongation to break is measured in % change of initial gauge length.

Heat seal initiation temperature is defined as the minimum temperature at which a 50 gf/in seal strength is achieved.

Hot tack initiation temperature is defined as the minimum seal temperature required to develop a 20 gf/in seal strength.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A multi-layer polymeric film comprising:
one or more structural layers of homogenous polypropylene having a melt flow rate from 0.5 to 10 MFR;
one or more structural layers of random copolymer polypropylene having a melt flow rate from 0.5 to 10 MFR;
one or more tie layers of anhydride modified polyethylene resin having a melt index from 0.7 to 3.5;
one or more linear low density polyethylene (LLDPE) blend sealant layers having a primary LLDPE component;
wherein the multi-layer polymeric film has an elongation at break measured in accordance with ASTM D 882 of greater than 400%, puncture strength greater than 7 lbs measured in accordance with ASTM D 7192; Spencer impact strength measured in accordance with ASTM D 3420 of more than 800 mJ; a seal initiation temperature less than or equal to 120° C.; a seal strength measured in accordance with ASTM F88-07a in the range of 100 gf/in to 2000 gf/in; and a seal window greater than 30° C.

2. The multi-layer polymeric film composition of claim 1 wherein the one or more LLDPE blend sealant layers further comprises a secondary LLDPE component.

3. The multi-layer polymeric film composition of claim 1 wherein the one or more LLDPE blend sealant layers further comprises a LDPE additive component.

4. The multi-layer polymeric film composition of claim 1, wherein the primary LLDPE component comprises a low long chain branching and heterogeneous molecular weight and short chain branching (comonomer) distribution.

5. The multi-layer polymeric film composition of claim 2, wherein the secondary LLDPE component comprises a low long chain branching and a homogeneous molecular weight and short chain branching comonomer distribution.

6. The multi-layer polymeric film composition of claim 1 wherein the one or more structural layers of homogenous polypropylene could contain up to 50% random copolymer or a polypropylene or polyethylene based plastomer/elastomer.

7. A multi-layer polymeric film comprising:
one or more layers of high density polyethylene (HDPE) having a melt index from 0.7 to 3.5,
one or more anhydride modified polyethylene based tie layers having a melt index from 0.7 to 3.5;
one or more structural layers of homogenous polypropylene being not directly exposed to the external environment and having a melt flow rate from 0.5 to 10 MFR;
one or more structural layers of random copolymer polypropylene having a melt flow rate from 0.5 to 10 MFR;
one or more linear low density polyethylene (LLDPE) blend sealant layers having a primary LLDPE component;
wherein the multi-layer polymeric film has an elongation at break measured in accordance with ASTM D 882 of greater than 400%, puncture strength greater than 7 lbs measured in accordance with ASTM D 7192; Spencer impact strength measured in accordance with ASTM D 3420 of more than 800 mJ; a seal initiation temperature less than or equal to 120° C.; a seal strength measured in accordance with ASTM F88-07a in the range of 100 gf/in to 2000 gf/in; and a seal window greater than 30° C.

8. The multi-layer polymeric film composition of claim 7 wherein the one or more LLDPE blend sealant layers further comprises a secondary LLDPE component.

9. The multi-layer polymeric film composition of claim 7 wherein the one or more LLDPE blend sealant layers further comprises a LDPE additive component.

10. The multi-layer polymeric film composition of claim 7 wherein the one or more layer of HDPE is from 0 to 30 weight percent, based on the total weight of the film.

11. The multi-layer polymeric film composition of claim 7 wherein the structural layer of homogenous polypropylene is from 10 to 50 weight percent of the film, based on the total weight of the film.

12. The multi-layer polymeric film composition of claim 7, wherein the one or more structural layer of homogenous polypropylene is a Metallocene catalysized based isotactic homoPP resin.

13. The multi-layer polymeric film composition of claim 7 wherein the one or more structural layer of random copolymer polypropylene is from 20 to 70 weight percent of the film, based on the total weight of the film.

14. The multi-layer polymeric film composition of claim 7 wherein the one or more sealant layer is from 10 to 35 weight percent of the film, based on the total weight of the film.

15. The multi-layer polymeric film composition of claim 8, wherein the secondary LLDPE component of the blend sealant layer is a Metallocene or post-Metallocene catalysized resin in an amount from 0 to 40 weight percent of the sealant layer blend, based on the total weight of the sealant layer blend.

16. The multi-layer polymeric film composition of claim 7, wherein the primary LLDPE component of the blend sealant layer is a Ziegler-Natta catalysized resin in an amount from 60 to 100 weight percent of the sealant layer blend, based on the total weight of the sealant layer blend.

17. The multi-layer polymeric film composition of claim 9, wherein the additive of the blend sealant layer is a low density polyethylene (LDPE) in an amount from 0 to 40 weight percent of the sealant layer blend, based on the total weight of the sealant layer blend.

18. The multi-layer polymeric film composition of claim 7, wherein the primary LLDPE component of the blend layer has a density in the range from 0.850 to 0.930 g/ cm³ and a melt index from 0.7 to 3.5 MI.

19. The multi-layer polymeric film composition of claim 8, wherein the secondary LLDPE component of the blend sealant layer has a density in the range from 0.850 to 0.930 g/cm³ and a melt index from 0.7 to 3.5 MI.

20. The multi-layer polymeric film composition of claim 8, wherein the secondary LLDPE component of the blend sealant layer is a second heterogeneous catalysized LLDPE and has a density in the range from 0.850 to 0.930 g/cm³ and a MI range from 0.7 to 3.5 MI.

21. A multi-layer polymeric film of claim 1 wherein the multi-layer polymeric film is thermoformable.

22. A multi-layer polymeric film of claim 1 wherein the multi-layer polymeric film is recyclable.

23. A multi-layer polymeric film of claim 7 wherein the multi-layer polymeric film is thermoformable.

24. A multi-layer polymeric film of claim 7 wherein the multi-layer polymeric film is recyclable.
